(19) United States
(12) Patent Application Publication
(10) Pub. No.: US 2026/0012499 A1
(43) Pub. Date: Jan. 8, 2026

(54) TERMINAL DEVICE, COMMUNICATION METHOD OF TERMINAL DEVICE, NON-TRANSITORY COMPUTER-READABLE RECORDING MEDIUM, AND COMMUNICATION SYSTEM

(71) Applicant: SHARP KABUSHIKI KAISHA, Osaka (JP)

(72) Inventor: Masami SHIGA, Osaka (JP)

(21) Appl. No.: 19/247,214

(22) Filed: Jun. 24, 2025

(30) Foreign Application Priority Data
Jul. 2, 2024 (JP) 2024-106930

(51) Int. Cl. H04L 67/025; H04L 9/40

(52) U.S. Cl. CPC H04L 67/025; H04L 63/029

(57) ABSTRACT

A terminal device comprises: a communicator that communicates with an external device via a network; and a controller that controls the communicator. The controller, when attempting to remotely operate an external device, establishes communication with the device or a mediation device that mediates the device and remotely operates the device in a case where direct communication is possible with an address of the device or the mediation device, and establishes communication with the device and remotely operates the device using a predetermined external system that relays remote operation with the device or the mediation device in a case where direct communication is not possible with an address of the device or the mediation device.

### FIELD OF THE DISCLOSURE

The present disclosure relates to a terminal device, a communication method of a terminal device, a non-transitory computer-readable recording medium, and a communication system, and more particularly, to a terminal device, a communication method of a terminal device, a non-transitory computer-readable recording medium, and a communication system that remotely operate an external device via a network.

### BACKGROUND ART

In the related art, a remote device operation system is known in which a mediation device connectable to a device existing in a local network is provided in the local network, and the device existing in the local network is remotely operated in a cloud.

For example, in a remote device management system in which a mediation device capable of acquiring device information from a device existing in a local network is provided in the local network and remote management is performed from the outside of the local network, there is a technique in which the mediation device communicates with a specific device based on a communication definition corresponding to a specific communication protocol.

There is also a technology that is a management system that remotely operates a control device (PLC) connected to a gateway device in a factory from a mobile terminal via a cloud, the technology allowing the mobile terminal that has moved into the factory to connect to the control device (PLC) via an access point in the factory based on route information acquired from the cloud with the mobile terminal itself as a gateway, allowing the mobile terminal that has moved into the factory to access the cloud via the gateway and execute management processing from the cloud via the gateway, and allowing the cloud to search a database by using presence information of the mobile terminal obtained by LAN connection and identify the factory in which the mobile terminal is present.

### SUMMARY

However, in such a remote device operation system, there is a case where direct communication with a device to be remotely operated cannot be performed due to a firewall or the like. In such a case, there is a method of realizing bidirectional communication by constructing and operating a Web server that proxies the communication, but the construction and operation of such a server incurs cost.

In particular, in a case where such an environment is constructed using a cloud service with usage-based billing, the user is charged for the amount of communication used, and thus there is a demand to suppress communication using the environment as much as possible.

The present disclosure has been made in view of the above circumstances, and an object thereof is to provide a terminal device, a communication method of a terminal device, non-transitory computer-readable recording medium, and a communication system that can establish communication with an external device more efficiently than in the related art when attempting to remotely operate the device via a network.

A terminal device according to one embodiment of the present disclosure is provided with a communicator that communicates with an external device via a network, and a controller that controls the communicator. The controller, when attempting to remotely operate an external device, establishes communication with the device or a mediation device that mediates the device and remotely operates the device in a case where direct communication is possible with an address of the device or the mediation device, and establishes communication with the device and remotely operates the device using a predetermined external system that relays remote operation with the device or the mediation device in a case where direct communication is not possible with an address of the device or the mediation device.

A communication method of a terminal device that communicates with an external device via a network according to one embodiment of the present disclosure comprises: when attempting to remotely operate an external device, establishing communication with the device or a mediation device that mediates the device and remotely operating the device in a case where direct communication is possible with an address of the device or the mediation device, and establishing communication with the device and remotely operating the device using a predetermined external system that relays remote operation with the device or the mediation device in a case where direct communication is not possible with an address of the device or the mediation device.

A non-transitory computer-readable recording medium according to one embodiment of the present disclosure stores therein a communication control program to be executed by a processor of a terminal device that communicates with an external device via a network to execute, the communication control program causing the processor to perform: when attempting to remotely operate an external device, establishing communication with the device or a mediation device that mediates the device and remotely operating the device in a case where direct communication is possible with an address of the device or the mediation device, and establishing communication with the device and remotely operating the device using a predetermined external system that relays remote operation with the device or the mediation device in a case where direct communication is not possible with an address of the device or the mediation device.

A communication system according to one embodiment of the present disclosure comprises a device and a terminal device communicably connected via a network. The terminal device, when attempting to remotely operate the device, establishes communication with the device or a mediation device that mediates the device and remotely operates the device in a case where direct communication is possible with an address of the device or the mediation device, and establishes communication with the device and remotely operates the device using a predetermined external system that relays remote operation with the device or the mediation device in a case where direct communication is not possible with an address of the device or the mediation device.

### BRIEF DESCRIPTION OF THE DRAWINGS

FIG. 1 is an explanatory diagram illustrating an example of a configuration of an image forming system including a digital multifunction peripheral according to the present disclosure.

FIG. 2 is an explanatory diagram illustrating a schematic configuration of a digital multifunction peripheral in FIG. 1.

FIG. 3 is an explanatory diagram illustrating a schematic configuration of a user terminal illustrated in FIG. 1.

FIG. 4 is an explanatory diagram illustrating a schematic configuration of a server illustrated in FIG. 1.

FIG. 5 is an explanatory diagram illustrating a problem of remote operation of a digital multifunction peripheral by a user terminal in the image forming system of the related art.

FIG. 6 is a flowchart illustrating an example of a flow of remote operation processing of the digital multifunction peripheral illustrated in FIG. 1.

FIG. 7 is an explanatory diagram illustrating an example of processing in the case where the digital multifunction peripheral in a local system is remotely operated from a user terminal outside the local system illustrated in FIG. 1.

FIG. 8 is an explanatory diagram illustrating an example of processing in the case where the digital multifunction peripheral in a local system is remotely operated from a user terminal inside the local system illustrated in FIG. 1.

FIG. 9 is an explanatory diagram illustrating an example of a configuration of remote operation of the digital multifunction peripheral by the user terminal in the image forming system illustrated in FIG. 1.

FIG. 10 is an explanatory diagram illustrating an example of a remote operation request screen displayed on a display of the user terminal illustrated in FIG. 1.

FIG. 11 is an explanatory diagram illustrating an example of a remote operation screen for the digital multifunction peripheral via a cloud network, displayed on a display of the user terminal illustrated in FIG. 1.

FIG. 12 is an explanatory diagram illustrating an example of the remote operation screen for the digital multifunction peripheral not via the cloud network, displayed on the display of the user terminal illustrated in FIG. 1.

FIG. 13 is an explanatory diagram illustrating another example of processing in the case where the digital multifunction peripheral in the local system is remotely operated from a user terminal outside the local system illustrated in FIG. 1.

### DESCRIPTION OF EMBODIMENTS

In the present disclosure, the “terminal device” is, for example, a terminal such as a personal computer (PC) or a tablet, a mobile terminal such as a smartphone, or the like.

The “device” is a device that has a communication function and can be remotely operated from the outside, such as a copier, a multifunction peripheral, an multifunctional peripheral (MFP) including functions other than copying, a television, a DVD recorder, a personal computer (PC), or an electronic blackboard.

The “mediation device” is a device that is connected to the terminal device and the device via the network and that transmits and receives various data pieces between the terminal device and the device to mediate the data.

The “external system” is a system including a device management apparatus that transmits connection information for establishing a connection with the mediation device in the local network to the terminal device when attempting to remotely operate the device from the terminal device, and a cloud network that connects the terminal device connected via the network to the mediation device in the local system.

Further, preferred aspects of the present disclosure will be described.

In the terminal device of the present disclosure, the device may be provided in a predetermined local network, and may communicate with the communicator via the mediation device, and when attempting to remotely operate the device, the controller may establish communication with the device via the mediation device and remotely operate the device in a case where direct communication is possible with an address of the mediation device, and may establish communication with the device via the mediation device and remotely operate the device using the external system in a case where direct communication is not possible with an address of the mediation device.

In this regard, when attempting to remotely operate an external device provided in the local network, by selecting direct connection to the mediation device or a connection using an external system according to the communication status, it is possible to realize a terminal device that can establish communication with the device more efficiently than in the related art.

In the terminal device of the present disclosure, the external system may include a device management apparatus that communicates with the mediation device via a firewall, and the controller may cause the communicator to acquire connection information for establishing a connection with the mediation device in the local network from the device management apparatus when attempting to remotely operate the device, and may establish communication with the device via the mediation device and remotely operate the device in a case where direct communication is possible with an address of the mediation device based on the connection information, and may establish communication with the device via the mediation device using the external system and remotely operates the device in a case where direct communication is not possible with an address of the mediation device based on the connection information.

In this regard, when attempting to remotely operate an external device provided in a local network, it is possible to realize a terminal device that can establish communication with the device more efficiently than in the related art by acquiring connection information for establishing a connection with the mediation device from a device management apparatus that communicates with the mediation device via a firewall, and selecting a direct connection with the mediation device or a connection using an external system according to the communication status.

In the terminal device of the present disclosure, the connection information may include information for determining that the device is an intended partner when the communicator performs communication with an address of the mediation device.

In this regard, when attempting to remotely operate an external device via a network, it is possible to realize the terminal device that can establish communication with the device more efficiently than in the related art by determining whether the address of the mediation device is reachable and by transmitting predetermined information to the mediation device to determine that the device is an intended partner when communicating with the mediation device.

In the terminal device of the present disclosure, the controller may transmit information related to an operation of the device to the mediation device and remotely operate the device in a case where the communicator establishes communication with the device via the mediation device, and may transmit information related to an operation of the device to the device management apparatus and remotely operate the device in a case where the communicator establishes communication with the device via the mediation device using the external system.

In this regard, when attempting to remotely operate an external device via a network, it is possible to realize the terminal device that can remotely operate the device more efficiently than in the related art by directly transmitting information related to the operation of the device to the mediation device or transmitting the information to the device management apparatus according to the communication status.

Hereinafter, the present disclosure will be described in further detail using the drawings. Note that the following description is in all aspects illustrative and it should not be understood as limiting the present disclosure.

### First Embodiment

### Schematic Configuration of Image Forming System 100

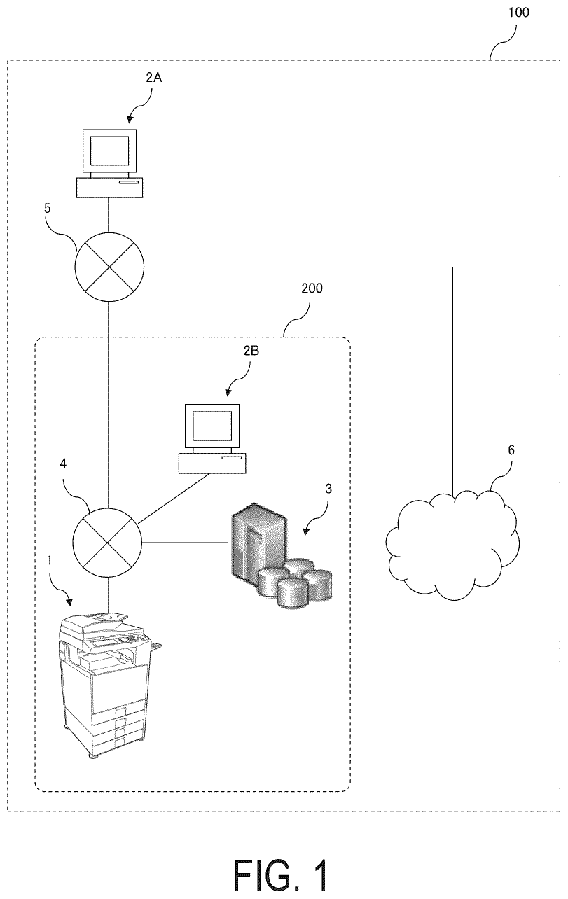

A schematic configuration of an image forming system 100 including a digital multifunction peripheral 1 according to Embodiment 1 of the present disclosure will be described based on FIGS. 1 to 4.

FIG. 1 is an explanatory diagram illustrating an example of a configuration of the image forming system 100 including the digital multifunction peripheral 1 according to the present disclosure.

As illustrated in FIG. 1, in the image forming system 100 of the present disclosure, the digital multifunction peripheral 1 is connected to user terminals 2A and 2B (hereinafter, also collectively referred to as the user terminal 2) and a server 3 via a wired or wireless local network 4 and the Internet 5.

The digital multifunction peripheral 1 is an image forming device such as a multifunction peripheral or MFP that digitally processes image data and has functions including copying, printing, scanning, and facsimile transmission.

The user terminal 2 may be a terminal such as a personal computer (PC) or tablet, or a mobile terminal such as a smartphone.

The user terminal 2 transmits and receives various data pieces to and from the digital multifunction peripheral 1 via the local network 4.

The server 3 is a mediation device that is connected to the digital multifunction peripheral 1 via the local network 4, is connected to the user terminal 2 via the Internet 5, and mediates by transmitting and receiving various data pieces between the user terminal 2 and the digital multifunction peripheral 1 via these networks.

The local network 4 is a network such as a LAN or a dedicated communication line that connects the digital multifunction peripheral 1, the user terminal 2B, and the server 3 to each other, and constitutes a local system 200. On the other hand, the user terminals 2A are assumed to be outside the local system 200.

The Internet 5 is a wide area network (WAN) that connects the user terminal 2A and the local system 200 to each other.

A cloud network 6 is a network provided by a cloud service, and connects the user terminals 2A connected via the Internet 5 to the server 3 in the local system 200.

The cloud network 6 includes a device management apparatus that communicates with the server 3 via a firewall.

When attempting remote operation from the user terminal 2 to the digital multifunction peripheral 1, the device management apparatus transmits connection information for establishing connection with the server 3 in the local network 4 to the user terminal 2.

In addition, in a case where the user terminal 2 establishes communication with the digital multifunction peripheral 1 via the server 3 using the cloud network 6, information related to the operation of the digital multifunction peripheral 1 is received from the user terminal 2 and transmitted to the digital multifunction peripheral 1 via the server 3, thereby realizing remote operation of the digital multifunction peripheral 1 by the user terminal 2.

### Schematic Configuration of Digital Multifunction Peripheral 1

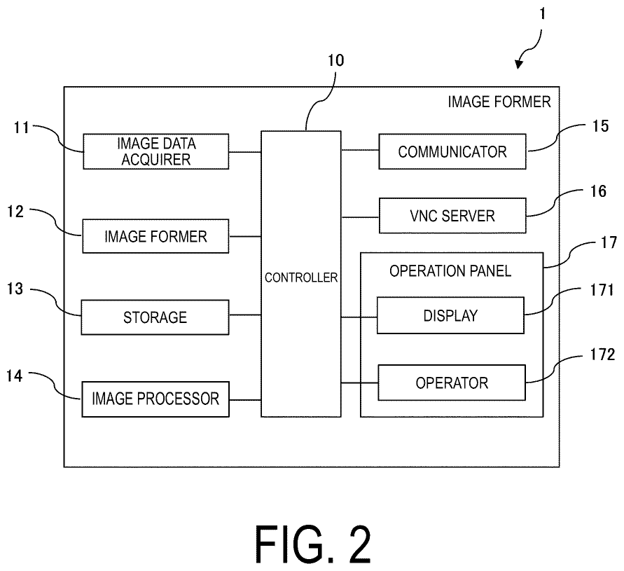

FIG. 2 is an explanatory diagram illustrating a schematic configuration of the digital multifunction peripheral 1 illustrated in FIG. 1.

As illustrated in FIG. 2, the digital multifunction peripheral 1 includes a controller 10, an image data acquirer 11, an image former 12, a storage 13, an image processor 14, a communicator 15, a VNC server 16, and an operation panel 17.

Hereinafter, each component of the digital multifunction peripheral 1 will be described.

The controller 10 integrally controls the digital multifunction peripheral 1 and includes at least one central processing unit (CPU), at least one random access memory (RAM), at least one read only memory (ROM), various interface circuits, and the like.

The controller 10 performs monitoring and controlling of detection of each sensor and all loads such as a motor, a clutch, and the operation panel 17 in order to control operation of the entire digital multifunction peripheral 1.

The image data acquirer 11 is a part that acquires image data received from an external device via the local network 4, the Internet 5, and the cloud network 6.

The image former 12 is a part that prints an image based on image data acquired by the image data acquirer 11 and processed by the image processor 14 onto paper.

The storage 13 is an element or a storage medium that stores information required to realize various functions of the digital multifunction peripheral 1, a control program, and the like. For example, a semiconductor device such as a RAM or a ROM or a storage medium such as a hard disk, a flash storage, or a solid state drive (SSD) is used.

Note that the program and the data may be held in different devices, for example, the region for holding data includes a hard disk drive and the region for holding the program includes a flash storage.

The image processor 14 is a part that converts image data input from the image data acquirer 11 into appropriate electrical signals and performs processing such as enlargement or reduction to make it suitable for output based on the analysis results of job instructions for printing or the like acquired from the user terminal via the communicator 15 or job instructions for printing or the like input from an operator 172.

The communicator 15 is a part that performs communication with the external device such as the user terminal 2 via the network and transmits and receives data and the like with these external devices.

The VNC server 16 is a server related to a service of virtual network computing (VNC). When the VNC server 16 receives a connection request from a VNC client 36 (described later) of an external device, the screen of the digital multifunction peripheral 1 is displayed on a display 241 of the user terminal 2 of the external device via the network, and the digital multifunction peripheral 1 can be remotely operated.

The VNC server 16 may be configured by installing a predetermined application.

When the VNC server 16 receives a connection request from the VNC client 36 (described later), the digital multifunction peripheral 1 can be remotely operated from an external device.

The operation panel 17 includes a display panel including a liquid crystal panel or the like and a capacitance touch panel that is disposed in a superimposed manner on the display panel and detects a position touched with a finger, and includes a display 171 and the operator 172.

The display 171 is a part that displays various types of information.

The display 171 is a display device such as a monitor or a line display that is configured with, for example, a CRT display, a liquid crystal display, or an EL display, and that displays electronic data such as processing status of the operating system or application software.

The controller 10 performs display of the operations and the states of the digital multifunction peripheral 1 through the display 171.

The operator 172 is an interface for operating the digital multifunction peripheral 1 and is a part that receives a command from the user.

The entirety of the operator 172 need not support touch panel operations, and some or all of the operator may be configured by physical keys independent of the display 171.

### Schematic Configuration of User Terminal 2

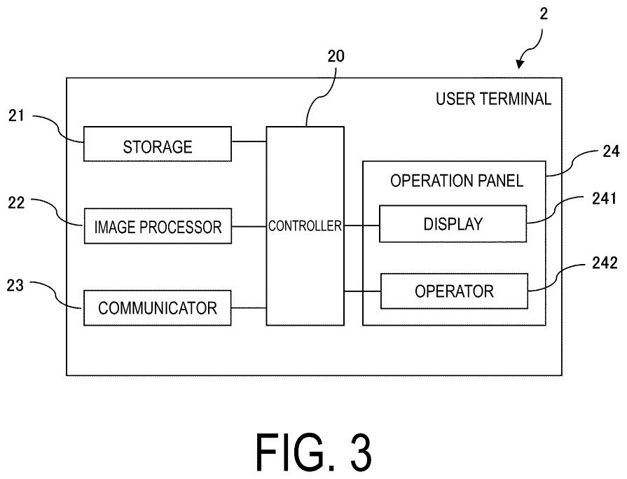

FIG. 3 is an explanatory diagram illustrating a schematic configuration of the user terminal 2 illustrated in FIG. 1.

As illustrated in FIG. 3, the user terminal 2 includes a controller 20, a storage 21, an image processor 22, a communicator 23, and an operation panel 24.

Hereinafter, each component of the user terminal 2 will be described.

The controller 20 integrally controls the user terminal 2 and includes at least one CPU, at least one RAM, at least one ROM, various interface circuits, and the like.

The controller 20 performs monitoring and control of detection of each sensor and all loads such as an operator 242 or the like in order to control operations of the entire user terminal 2.

The storage 21 is an element or a storage medium that stores information, a control program, and the like required to realize various functions of the user terminal 2.

For example, a semiconductor device such as a RAM or a ROM or a storage medium such as a hard disk, a flash storage, or an SSD is used.

The storage 21 stores information related to a job such as printing and data required to execute the job such as image data.

Note that the program and the data may be held in different devices, for example, the region for holding data includes a hard disk drive and the region for holding the program includes a flash storage.

The image processor 22 is a part that converts the image data into an appropriate electric signal and performs processing such as enlargement or shrinking for appropriate outputting.

The communicator 23 is a part that performs communication with the external digital multifunction peripheral 1 and the server 3 via the network and transmits and receives a command for a job such as printing, original document image data, and the like.

Also, the communicator 23 is a part that performs communication with external devices such as an image forming device, a mobile information terminal, an information processing device, and a facsimile device and transmits and receives various types of information such as e-mails and faxes to and from these external devices.

The operation panel 17 includes a display panel including a liquid crystal panel or the like and a capacitance touch panel that is disposed in a superimposed manner on the display panel and detects a position touched with a finger, and includes the display 241 and the operator 242.

The display 241 is a part that displays various types of information.

The display 241 is a display device such as a monitor or a line display that is configured with, for example, a CRT display, a liquid crystal display, or an EL display, and that displays electronic data such as processing status of the operating system or application software.

The controller 20 performs display of operations and states of the user terminal 2 through the display 241.

The operator 242 is an interface for operating the user terminal 2 and is a part that receives a command from the user.

The display 241 and the operator 242 may include a display panel including a liquid crystal panel or the like and a capacitance touch panel that is disposed in a superimposed manner on the display panel and detects a position touched with a finger.

### Schematic Configuration of Server 3

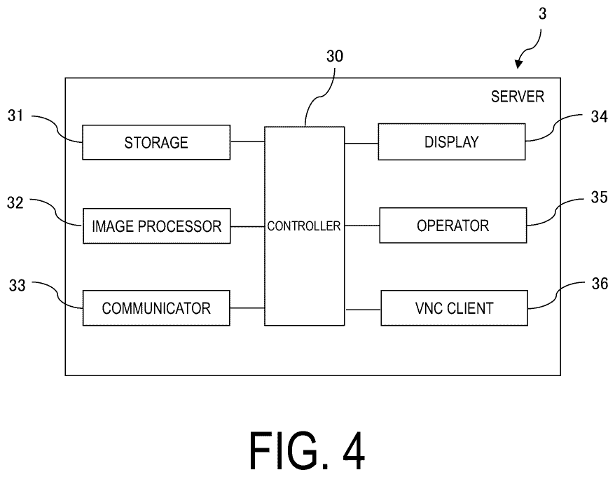

Next, a schematic configuration of the server 3 will be described based on FIG. 4.

FIG. 4 is a block diagram illustrating a schematic configuration of the server 3 illustrated in FIG. 1.

As illustrated in FIG. 4, the server 3 includes a controller 30, a storage 31, an image processor 32, a communicator 33, a display 34, an operator 35, and a VNC client 36.

Hereinafter, each component of the server 3 will be described.

The controller 30 integrally controls the server 3 and includes at least one CPU, at least one RAM, at least one ROM, various interface circuits, and the like.

The storage 31 is an element or a storage medium that stores information required to realize various functions of the server 3, a control program, and the like. For example, a semiconductor device such as a RAM or a ROM or a storage medium such as a hard disk, a flash storage, or an SSD is used.

The image processor 32 is a part that performs processing to be suitable for output such as enlargement and reduction of an image displayed on the display 34 based on a command of the operator 35.

The communicator 33 is a part that performs communication with the digital multifunction peripheral 1, the user terminal 2, and the like via the network and transmits and receives a command for a job such as printing, original document image data, and the like.

The display 34 is a part that includes a display panel including a liquid crystal panel or the like and displays various types of information.

The display 34 is a display device such as a monitor or a line display that is configured with, for example, a CRT display, a liquid crystal display, or an EL display, and that displays electronic data such as processing status of the operating system or application software.

The controller 30 performs display of operations and states of the server 3 through the display 34.

The operator 35 is an interface for operating the server 3 and is a part that receives a command from the management user of the server 3.

The VNC client 36 is a client related to a service of virtual network computing (VNC).

The VNC client 36 may be configured by installing a predetermined application.

### Problems of Image Forming System of Related Art

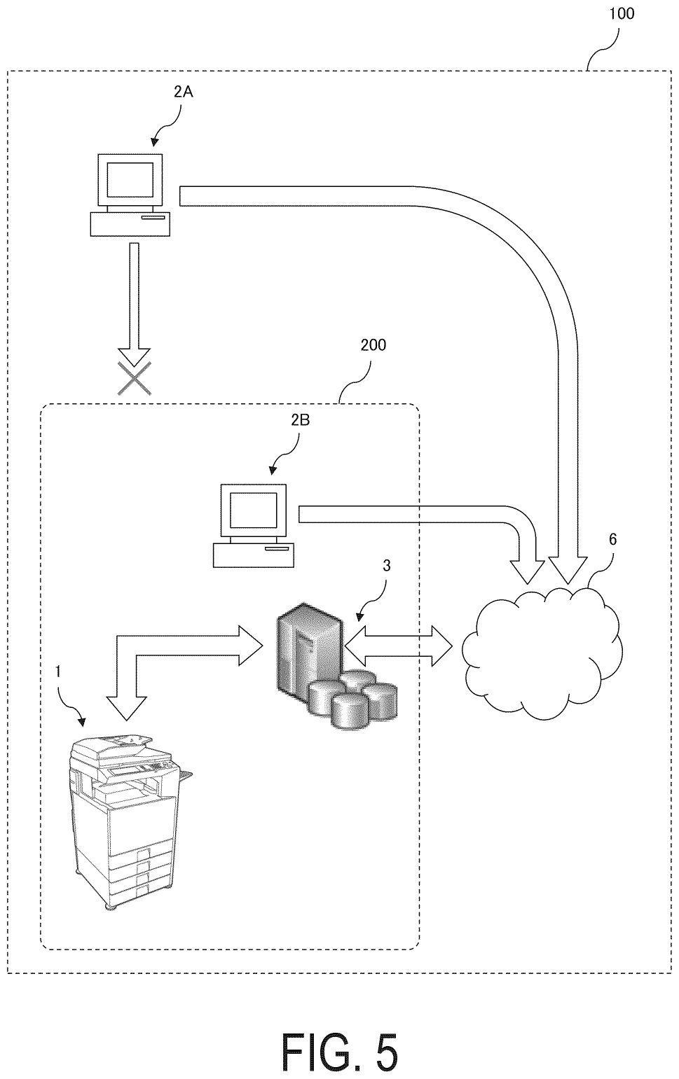

FIG. 5 is an explanatory diagram illustrating a problem of remote operation of the digital multifunction peripheral 1 by the user terminal 2 in the image forming system 100 of the related art.

In the related art, there is a case where direct communication with the digital multifunction peripheral 1 in the local system 200 cannot be performed due to a firewall or the like.

In such a case, the user terminals 2A cannot directly access the digital multifunction peripheral 1. However, as illustrated in FIG. 5, the digital multifunction peripheral 1 can be remotely operated by accessing the server 3, which is a mediation device of the digital multifunction peripheral 1, via the cloud network 6.

However, constructing and operating such an environment incur costs. In particular, in a case where such an environment is constructed using a cloud service with usage-based billing, there is a problem that the user is charged for the amount of use of the communication.

### Flow of Remote Operation Processing of Digital Multifunction Peripheral 1 According to Embodiment 1 of the Present Disclosure

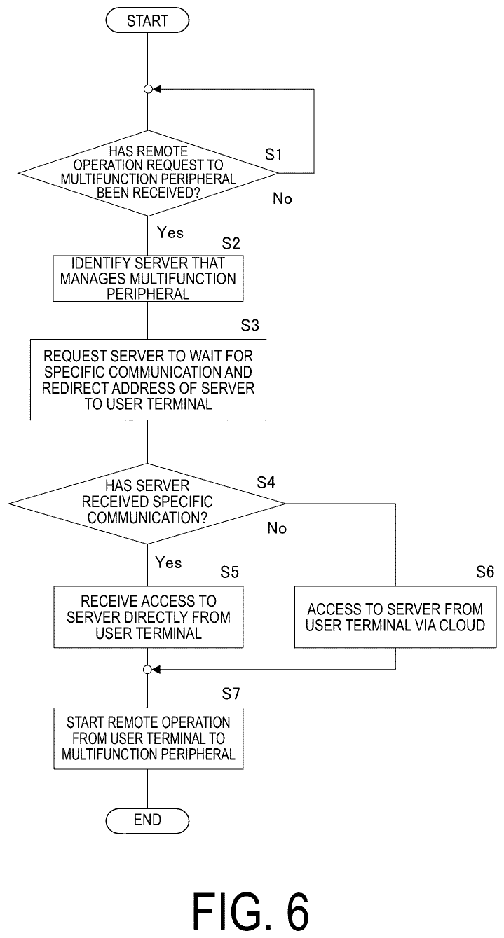

Next, the flow of remote operation processing of the digital multifunction peripheral 1 according to Embodiment 1 of the present disclosure will be described based on FIGS. 6 to 13.

FIG. 6 is a flowchart illustrating an example of the flow of the remote operation processing of the digital multifunction peripheral 1 illustrated in FIG. 1.

In step S1 of FIG. 6, the cloud network 6 determines whether a remote operation request to the digital multifunction peripheral 1 has been received from the user terminal 2 (step S1).

In a case where the remote operation request to the digital multifunction peripheral 1 is received from the user terminal 2 (in a case where the determination of step S1 is Yes), in step S2, the cloud network 6 identifies the server 3 which is the mediation device managing the digital multifunction peripheral 1 via the communicator 15 (step S2).

Next, in step S3, the cloud network 6 requests the server 3 identified in step S2 to wait for specific communication (step S3).

In addition, the cloud network 6 redirects the address of the server 3 and the specific communication (information) for accessing the server 3 to the user terminal 2 that has transmitted the remote operation request.

Examples of such specific communication (information) include use of a specific signature and access to a specific port number.

Next, in step S4, the controller 30 of the server 3 determines whether the communicator 33 has received the specific communication (step S4).

In a case where the communicator 33 receives the specific communication (in a case where the determination in step S4 is Yes), in step S5, the controller 30 receives access to the server 3 directly from the user terminal 2 that has transmitted the specific communication (step S5).

On the other hand, in a case where the communicator 33 does not receive the specific communication due to the firewall or the like of the local system 200 (in a case where the determination in step S4 is No), in step S6, the controller 20 of the user terminal 2 that has transmitted the specific communication causes the communicator 23 to access the server 3 via the cloud network 6 (step S6).

After the processing of step S5 or step S6, the user terminal 2 starts the remote operation of the digital multifunction peripheral 1 in step S7 (step S7).

### Example 1

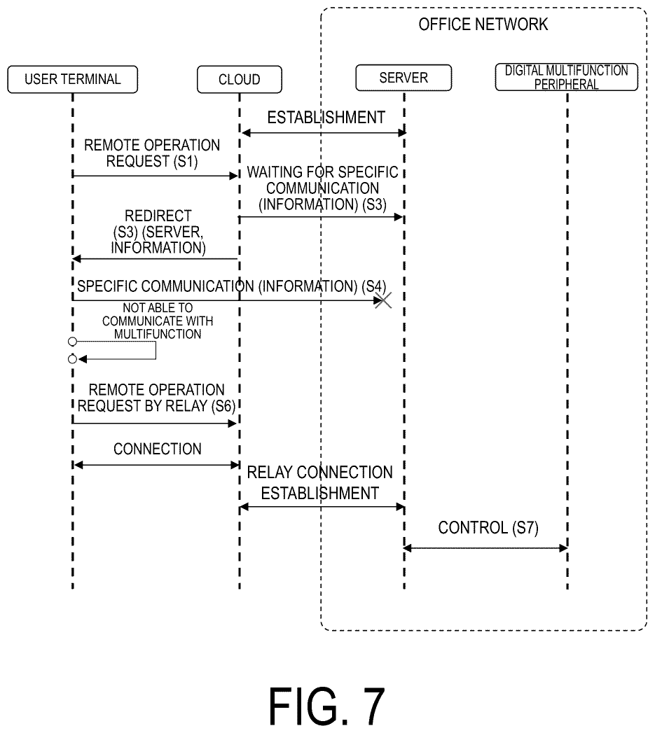

FIG. 7 is an explanatory diagram illustrating an example of processing in a case where the digital multifunction peripheral 1 in the local system 200 is remotely operated from the user terminals 2A outside the local system 200 illustrated in FIG. 1.

In the example of FIG. 7, the digital multifunction peripheral 1 and the server 3, which is a mediation device of the digital multifunction peripheral 1, are provided in an office network as the local system 200.

On the other hand, the user terminal 2A and the cloud network 6 are provided outside the office network.

It is assumed that a connection between the server 3 and the cloud network 6 is established.

The cloud network 6 determines whether a remote operation request to the digital multifunction peripheral 1 has been received from the user terminal 2A.

The cloud network 6 identifies the server 3 which is a mediation device managing the digital multifunction peripheral 1, and requests the server 3 to wait for specific communication (information).

In addition, the cloud network 6 redirects the address of the server 3 and specific communication (information) for accessing the server 3 to the user terminal 2A.

Subsequently, the server 3 determines whether the specific communication (information) is received from the user terminal 2A. In the example of FIG. 7, it is assumed that the server 3 does not receive the specific communication (information) from the user terminal 2A due to the firewall of the office network.

In this case, the user terminal 2A performs a remote operation request to the digital multifunction peripheral 1 by relay via the cloud network 6, assuming that communication from the user terminal 2A to the server 3 is impossible.

Then, when the connection between the user terminal 2A and the cloud network 6 is established and the relay connection to the server 3 via the cloud network 6 is established, the remote operation from the user terminal 2A to the digital multifunction peripheral 1 is started.

### Example 2

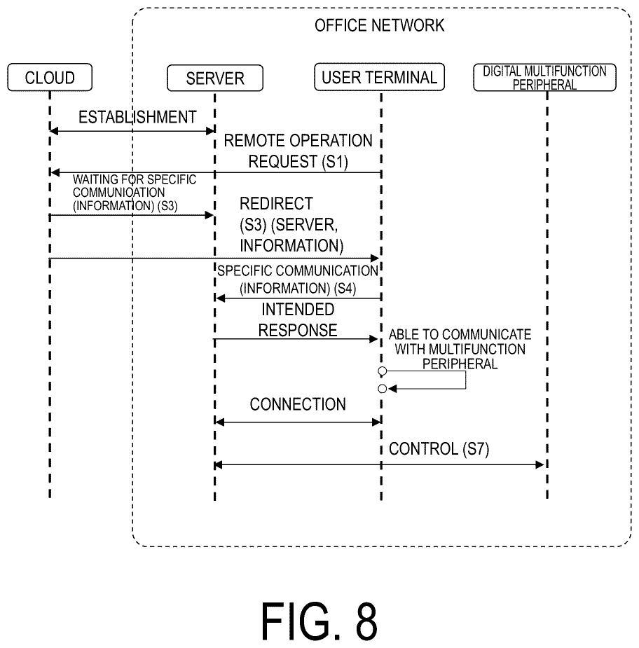

FIG. 8 is an explanatory diagram illustrating an example of processing in the case where the digital multifunction peripheral 1 in the local system 200 is remotely operated from the user terminal 2B in the local system 200 illustrated in FIG. 1.

In the example of FIG. 8, the user terminal 2A, the digital multifunction peripheral 1, and the server 3 that is a mediation device of the digital multifunction peripheral 1 are provided in an office network as the local system 200.

On the other hand, a cloud network 6 is provided outside the office network.

It is assumed that a connection between the server 3 and the cloud network 6 is established.

The cloud network 6 determines whether a remote operation request to the digital multifunction peripheral 1 has been received from the user terminal 2B.

The cloud network 6 identifies the server 3 which is a mediation device managing the digital multifunction peripheral 1, and requests the server 3 to wait for specific communication (information).

In addition, the cloud network 6 redirects the address of the server 3 and specific communication (information) for accessing the server 3 to the user terminal 2B.

Subsequently, the server 3 determines whether the specific communication (information) is received from the user terminal 2B. In the example of FIG. 8, it is assumed that the server 3 receives specific communication (information) from the user terminal 2B.

In this case, the user terminal 2B directly performs a remote operation request to the digital multifunction peripheral 1 via the server 3 without passing through the cloud network 6, assuming that communication from the user terminal 2B to the server 3 is possible.

When the connection between the user terminal 2B and the server 3 is established, the remote operation from the user terminal 2B to the digital multifunction peripheral 1 is started.

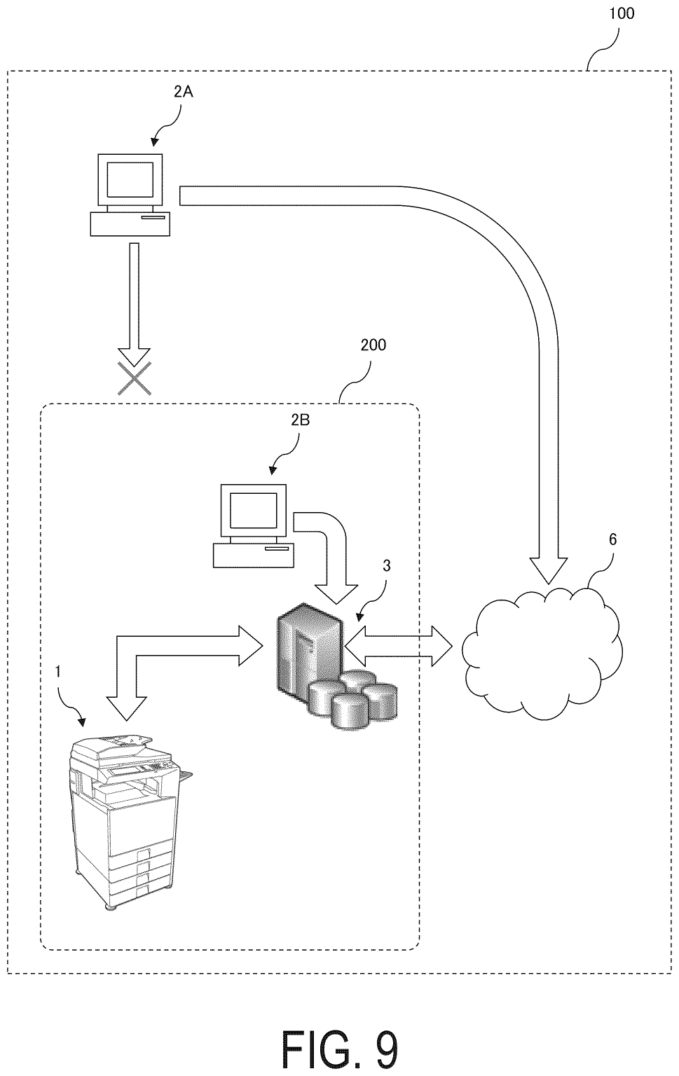

FIG. 9 is an explanatory diagram illustrating an example of a configuration of remote operation of the digital multifunction peripheral 1 by the user terminal 2 in the image forming system 100 illustrated in FIG. 1.

As illustrated in FIG. 9, the user terminal 2A accesses the server 3, which is a mediation device of the digital multifunction peripheral 1, via the cloud network 6, while the user terminal 2B can directly execute remote operation on the digital multifunction peripheral 1 via the server 3 without passing through the cloud network 6.

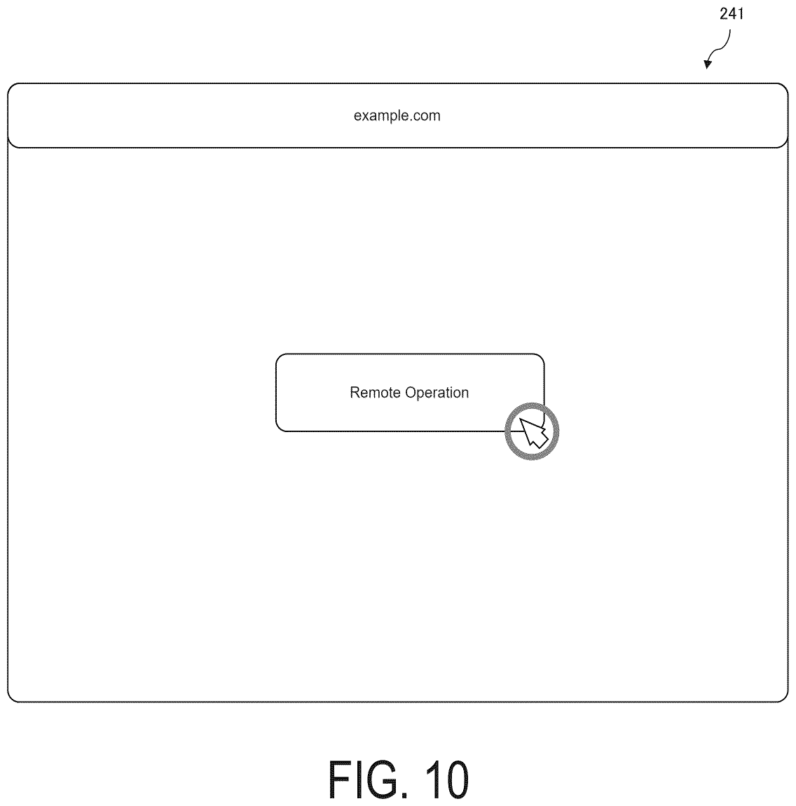

FIG. 10 is an explanatory diagram illustrating an example of a remote operation request screen displayed on the display 241 of the user terminal 2 illustrated in FIG. 1.

As illustrated in FIG. 10, the user can perform a remote operation request by pressing a “Remote Operation” button displayed on the display 241.

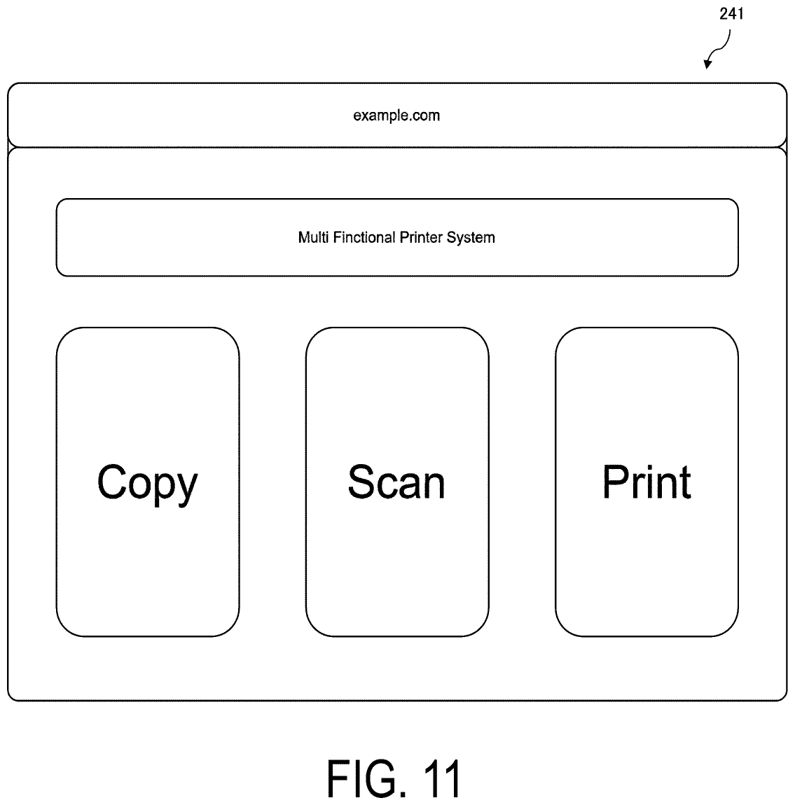

FIG. 11 is an explanatory diagram illustrating an example of a remote operation screen of the digital multifunction peripheral 1 via the cloud network 6 displayed on the display 241 of the user terminal 2 illustrated in FIG. 1.

As illustrated in FIG. 11, in a case where the digital multifunction peripheral 1 is remotely operated via the cloud network 6, the URL of the Internet environment (for example: “example.com”) is displayed in the address bar.

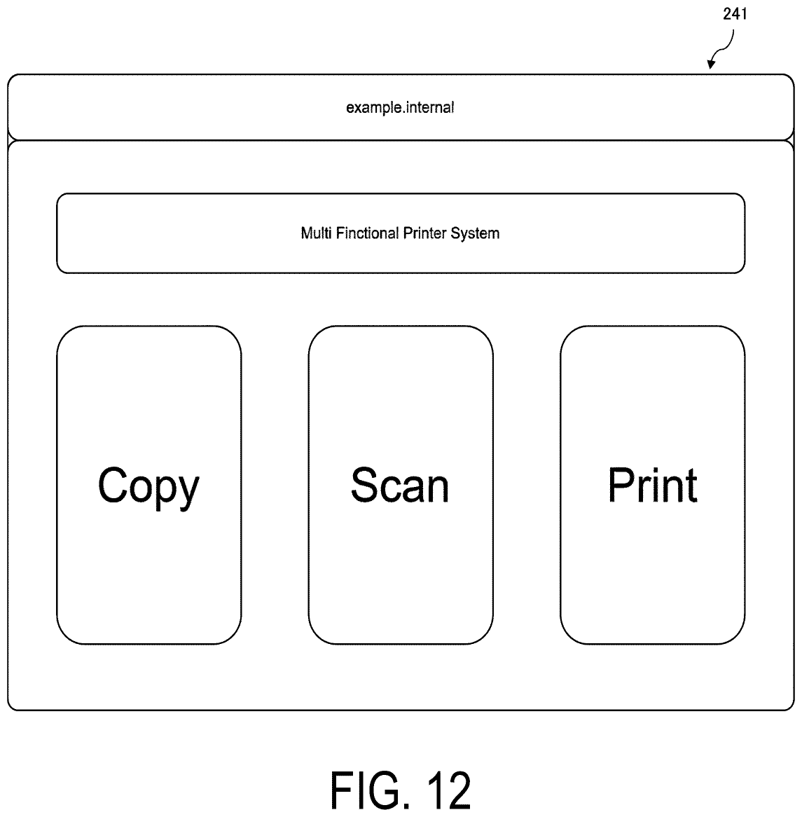

FIG. 12 is an explanatory diagram illustrating an example of a remote operation screen of the digital multifunction peripheral 1 not via the cloud network 6 displayed on the display 241 of the user terminal 2 illustrated in FIG. 1.

As illustrated in FIG. 12, in a case where the digital multifunction peripheral 1 is remotely operated via the cloud network 6, the URL of the private network (for example, “example internal”, “192.168.0.3”, or the like) is displayed in the address bar.

### Example 3

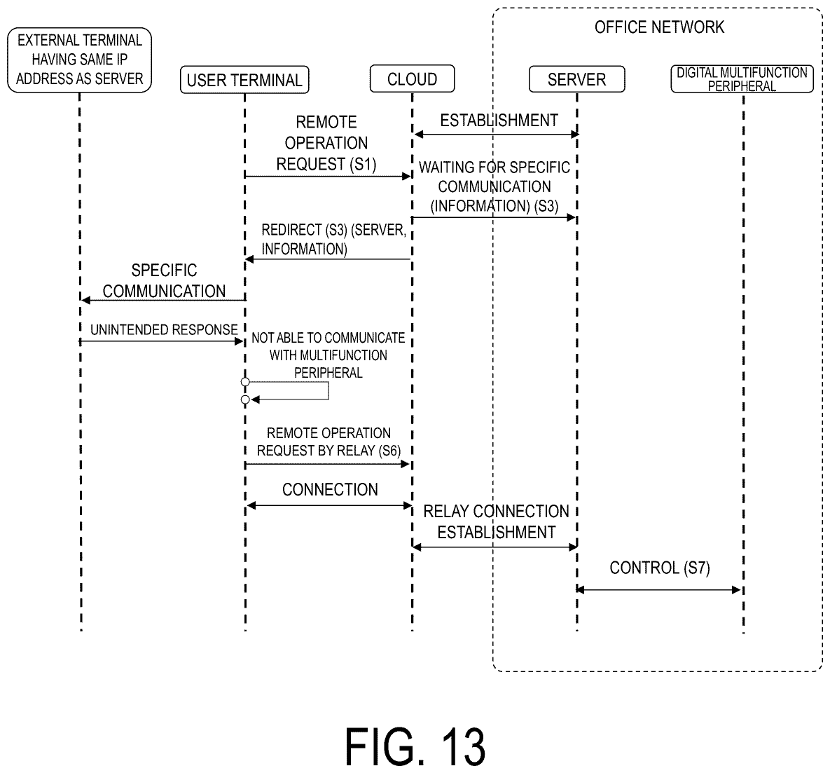

FIG. 13 is an explanatory diagram illustrating another example of the processing in the case where the digital multifunction peripheral 1 in the local system 200 is remotely operated from the user terminal 2B outside the local system 200 illustrated in FIG. 1.

In the example of FIG. 13, the digital multifunction peripheral 1 and the server 3, which is a mediation device of the digital multifunction peripheral 1, are provided in an office network as the local system 200.

On the other hand, the user terminal 2A and the cloud network 6 are provided outside the office network.

It is assumed that a connection between the server 3 and the cloud network 6 is established.

Further, it is assumed that an external terminal having the same IP address as the server 3 is provided outside the office network.

The cloud network 6 determines whether a remote operation request to the digital multifunction peripheral 1 has been received from the user terminal 2A.

The cloud network 6 identifies the server 3 which is a mediation device managing the digital multifunction peripheral 1, and requests the server 3 to wait for specific communication (information).

In addition, the cloud network 6 redirects the address of the server 3 and specific communication (information) for accessing the server 3 to the user terminal 2A.

Here, the specific communication (information) from the user terminal 2A may be received by an external device having the same IP address as the server 3.

In order to avoid such a problem, when communication is performed with the IP address of the server 3, it is determined whether the communication partner is the intended communication partner, for example, based on whether predetermined information matches.

The server 3 sets an endpoint for connection confirmation with predetermined information based on an instruction from the device management apparatus.

In this regard, when specific communication (information) is received from an external terminal having the same IP address as the server 3, it is possible to determine that the specific communication is an unintended response.

As a result, the user terminal 2A determines that communication from the user terminal 2A to the server 3 is impossible, and the user terminal 2A performs a remote operation request to the digital multifunction peripheral 1 by relay via the cloud network 6.

Then, when the connection between the user terminal 2A and the cloud network 6 is established and the relay connection to the server 3 via the cloud network 6 is established, the remote operation from the user terminal 2A to the digital multifunction peripheral 1 is started.

In this manner, when the digital multifunction peripheral 1 is remotely operated from the user terminal 2, the connection through an appropriate path is selected according to the communication status, and thus it is possible to realize the image forming system 100 capable of establishing communication with the digital multifunction peripheral 1 more efficiently than in the related art.

Preferred aspects of the present disclosure include combinations of any of the multiple aspects described above.

Various modification examples of the present disclosure are also possible as well as the aforementioned embodiments. It should not be understood that the modifications do not belong to the scope of the present disclosure. The present disclosure shall include meanings equivalent to the scope of the claims and all modifications within the scope.

### CROSS REFERENCE TO RELATED APPLICATION

The present application claims priority from Japanese Application JP2024-106930, filed on Jul. 2, 2024, the content of which is hereby incorporated by reference into this application.

1. A terminal device comprising:
a communicator that communicates with an external device via a network; and
a controller that controls the communicator, wherein
the controller, when attempting to remotely operate an external device, establishes communication with the device or a mediation device that mediates the device and remotely operates the device in a case where direct communication is possible with an address of the device or the mediation device, and establishes communication with the device and remotely operates the device using a predetermined external system that relays remote operation with the device or the mediation device in a case where direct communication is not possible with an address of the device or the mediation device.

2. The terminal device according to claim 1, wherein
the device is provided in a predetermined local network, and communicates with the communicator via the mediation device, and
the controller, when attempting to remotely operate the device, establishes communication with the device via the mediation device and remotely operates the device in a case where direct communication is possible with an address of the mediation device, and establishes communication with the device via the mediation device and remotely operates the device using the external system in a case where direct communication is not possible with an address of the mediation device.

3. The terminal device according to claim 2, wherein
the external system includes a device management apparatus that communicates with the mediation device via a firewall, and
the controller causes the communicator to acquire connection information for establishing a connection with the mediation device in the local network from the device management apparatus when attempting to remotely operate the device, and
establishes communication with the device via the mediation device and remotely operates the device in a case where the direct communication is possible with an address of the mediation device based on the connection information, and establishes communication with the device via the mediation device and remotely operates the device using the external system in a case where the direct communication is not possible based on the connection information.

4. The terminal device according to claim 3, wherein the connection information includes information for determining that the communicator is an intended partner in a case where the device performs communication with an address of the mediation device.

5. The terminal device according to claim 3, wherein the controller transmits information related to an operation of the device to the mediation device and remotely operates the device in a case where the communicator establishes communication with the device via the mediation device, and transmits information related to an operation of the device to the device management apparatus and remotely operates the device in a case where the communicator establishes communication with the device via the mediation device using the external system.

6. A communication method of a terminal device that communicates with an external device via a network, the communication method comprising:
when attempting to remotely operate an external device, establishing communication with the device or a mediation device that mediates the device and remotely operating the device in a case where direct communication is possible with an address of the device or the mediation device, and establishing communication with the device and remotely operating the device using a predetermined external system that relays remote operation with the device or the mediation device in a case where direct communication is not possible with an address of the device or the mediation device.

7. A non-transitory computer-readable recording medium storing therein a communication control program to be executed by a processor of a terminal device that communicates with an external device via a network to execute, the communication control program causing the processor to perform:
when attempting to remotely operate an external device, establishing communication with the device or a mediation device that mediates the device and remotely operating the device in a case where direct communication is possible with an address of the device or the mediation device, and establishing communication with the device and remotely operating the device using a predetermined external system that relays remote operation with the device or the mediation device in a case where direct communication is not possible with an address of the device or the mediation device.

8. A communication system comprising:
a device and a terminal device communicably connected via a network, wherein
the terminal device, when attempting to remotely operate the device, establishes communication with the device or a mediation device that mediates the device and remotely operates the device in a case where direct communication is possible with an address of the device or the mediation device, and establishes communication with the device and remotely operates the device using a predetermined external system that relays remote operation with the device or the mediation device in a case where direct communication is not possible with an address of the device or the mediation device.
